(19) United States
(12) Patent Application Publication
(10) Pub. No.: US 2010/0110715 A1
(43) Pub. Date: May 6, 2010

(54) VEHICULAR LAMP UNIT AND VEHICULAR LAMP

(75) Inventor: Yusuke Nakada, Shizuoka (JP)

Correspondence Address: OSHA LIANG L.L.P., TWO HOUSTON CENTER, 909 FANNIN, SUITE 3500, HOUSTON, TX, 77010, US

(73) Assignee: KOITO MANUFACTURING CO., LTD., Tokyo (JP)

(21) Appl. No.: 12/607,628

(22) Filed: Oct. 28, 2009

(30) Foreign Application Priority Data
Oct. 30, 2008 (JP) 2008-278979

(51) Int. Cl. B60Q 1/00; H01J 9/00

(52) U.S. Cl. 362/538; 445/23

(57) ABSTRACT

A vehicular lamp unit includes a projection lens disposed on an optical axis extending in a vehicular longitudinal direction; a light source disposed rearward of a rear side focal point of the projection lens; a reflector reflecting direct light from the light source forward towards the optical axis; a shade disposed between the projection lens and the light source such that the shade blocks a part of reflected light from the reflector and a part of the direct light from the light source to form a cut-off line of a light distribution pattern; a first reflective surface formed on a tip portion of the reflector such that the first reflective surface reflects a part of the direct light from the light source downward to the front of the shade; and a second reflective surface formed on the front of the shade and below the rear side focal point of the projection lens such that the second reflective surface reflects reflected light from the first reflective surface towards the projection lens so that upward directed radiated light is emitted from the projection lens. The second reflective surface includes a vertically divided upper-side second reflective surface and lower-side second reflective surface. Radiated light provided by the lower-side second reflective surface radiates above radiated light provided by the upper-side second reflective surface.

### BACKGROUND OF INVENTION

1. Field of the Invention

The present invention relates to a vehicular lamp unit and a vehicular lamp of so-called projector-type, and particularly relates to a vehicular lamp unit and a vehicular lamp provided with a shade that forms a cut-off line of a light distribution pattern.

2. Related Art

Conventionally, as one form of a vehicular lamp such as a headlamp, a so-called projector-type vehicular lamp is known. This projector-type vehicular lamp is structured to collect and reflect light from a light source disposed on an optical axis to the front towards the optical axis using a reflector, and to radiate the reflected light to the front of the lamp via a projection lens provided in front of the reflector.

It is common that, when such a projector-type lamp unit is used as a low-beam headlamp, a shade is provided between the projection lens and the light source, and a part of the reflected light from the reflector and a part of direct light from the light source are blocked by the shade, thereby forming a cut-off line of a light distribution pattern. Therefore, for instance, the light that is incident below the reflector and is blocked by the shade becomes loss of light that does not contribute to the light distribution projected forward. Particularly, when a semiconductor light-emitting element is used as the light source, an amount of radiated light is likely to be insufficient.

Accordingly, there has been proposed a projector-type lamp unit provided with a main reflector having a first reflective surface that reflects direct light from a light source to the front towards an optical axis, and a sub-reflector including a shade mechanism having a second reflective surface disposed in between a convex lens (projection lens) and the light source and formed in a generally flat shape along an optical axis of the convex lens (for instance, Patent Document 1).

With the use of such a lamp unit, by reflecting a part of reflected light from the main reflector upward using the second reflective surface of the sub-reflector, it is possible to effectively utilize the light, which is blocked and thus not used, to perform beam radiation to the lower side of a cut-off line.

[Patent Document 1] Japanese Patent Application Laid-Open (Kokai) No. JP-A-2006-107955

### SUMMARY OF INVENTION

However, even when a part of the reflected light from the main reflector is reflected upward by the second reflective surface of the sub-reflector as in the above-described lamp unit, the light cannot be radiated at all above the cut-off line of the light distribution pattern. If the light is not radiated at all above the cut-off line, a forward visibility is not good, and it is hard to recognize an object on an opposite lane. Specifically, radiated light with such a level that the light does not give a glare to a vehicle on the opposite lane is necessary for improving the forward visibility also above a cut-off line in a low-beam light distribution pattern.

Accordingly, one or more embodiments of the present invention provide a vehicular lamp unit and a vehicular lamp capable of improving a forward visibility by radiating light also above a cut-off line of a light distribution pattern.

One or more embodiments of the present invention relate to a vehicular lamp unit having a projection lens disposed on an optical axis extending in a vehicular longitudinal direction, a light source disposed rearward of a rear side focal point of the projection lens, a reflector reflecting direct light from the light source to the front towards the optical axis, and a shade disposed between the projection lens and the light source and blocking a part of reflected light from the reflector and a part of the direct light from the light source to form a cut-off line of a light distribution pattern. The vehicular lamp unit is characterized by including: a first reflective surface that is formed on a tip portion of the reflector and reflects a part of the direct light from the light source downward to the front of the shade; and a second reflective surface that is formed on the front of the shade and below the rear side focal point of the projection lens, and reflects reflected light from the first reflective surface towards the projection lens so that upward directed radiated light is emitted from the projection lens. In the vehicular lamp unit, the second reflective surface has vertically divided upper-side second reflective surface and lower-side second reflective surface, and radiated light provided by the lower-side second reflective surface radiates above radiated light provided by the upper-side second reflective surface.

With the use of the vehicular lamp unit structured as above, after a part of the direct light from the light source is reflected by the first reflective surface formed on the tip portion of the reflector, the light is further reflected towards the projection lens by each of the vertically divided upper-side second reflective surface and lower-side second reflective surface formed on the front of the shade and below the rear side focal point of the projection lens. Subsequently, the light incident on the projection lens from each of the upper-side second reflective surface and the lower-side second reflective surface is emitted as the upward directed radiated light, which enables radiation of two, vertically-divided areas above the cut-off line of the light distribution pattern.

In one or more embodiments, it is preferable that, in the vehicular lamp unit structured as above, the first reflective surface have a front-side first reflective surface and a rear-side first reflective surface which are divided in a longitudinal direction, the front-side first reflective surface be formed in a shape of an ellipsoidal reflective surface having a vertical cross-section that is generally ellipsoidal in shape and whose first focal point and second focal point are respectively set to the light source and a position above the rear side focal point of the projection lens, the rear-side first reflective surface be formed in a shape of a parabolic reflective surface having a vertical cross-section that is generally parabolic in shape and whose focal point is set to the light source, and reflected light from the front-side first reflective surface be incident on the upper-side second reflective surface, and reflected light from the rear-side first reflective surface is incident on the lower-side second reflective surface.

With the use of the vehicular lamp unit having such a structure, the reflected light from the front-side first reflective surface formed in a shape of an ellipsoidal reflective surface is incident on the upper-side second reflective surface, and the reflected light from the rear-side first reflective surface formed in a shape of a parabolic reflective surface is incident on the lower-side second reflective surface, so that the light can be effectively incident on the upper-side second reflective surface on which it is difficult for the reflected light from the first reflective surface to be incident.

Further, it is preferable that, in the vehicular lamp unit structured as above, the upper-side second reflective surface be formed in a shape of a generally flat surface having a linear vertical cross-section, and the lower-side second reflective surface be formed in a shape of a generally curved surface having a curved vertical cross-section and smoothly formed continuously to a lower portion of the upper-side second reflective surface.

With the use of the vehicular lamp unit having such a structure, the lower-side second reflective surface formed in a shape of a generally curved surface can effectively reflect the reflected light from the rear-side first reflective surface having a sharp angle towards the projection lens without interfering with the reflected light from the reflector. Further, because the lower-side second reflective surface is smoothly continued to the lower portion of the upper-side second reflective surface, an unevenness is unlikely to occur in the upward directed radiated light emitted from the projection lens.

Further, one or more embodiments of the present invention relate to a vehicular lamp characterized in that an entire light distribution pattern is formed by combining a light distribution from the vehicular lamp unit structured as above and a light distribution from another vehicular lamp unit having a light collecting power lower than that of the above vehicular lamp unit.

With the use of the vehicular lamp structured as above, when light distributions from a plurality of lamp units are combined to form an entire light distribution pattern, by forming the first reflective surface on the tip portion of the reflector in the light collecting-type lamp unit having a light collecting power higher than that of another vehicular lamp unit, it is possible to minimize an influence on an effective reflective surface of the reflector.

With the use of the vehicular lamp unit according to one or more embodiments of the present invention, the light incident on the projection lens from each of the upper-side second reflective surface and the lower-side second reflective surface after being reflected by the first reflective surface is emitted as the upward directed radiated light, which enables radiation of two, vertically-divided areas above the cut-off line of the light distribution pattern. Accordingly, an optimum light distribution pattern can be formed, and, therefore, forward visibility can be improved.

Other aspects and advantages of the invention will be apparent from the following description, the drawings and the claims.

### BRIEF DESCRIPTION OF DRAWINGS

FIG. 1 is a horizontal cross sectional view of a vehicular lamp according to one or more embodiments of the present invention.

FIG. 2 is an arrow view along the line II-II in FIG. 1.

FIG. 3 is a longitudinal sectional view that explains a basic structure of a lamp unit shown in FIG. 2.

FIG. 4 is an expanded sectional view of a substantial part of the lamp unit shown in FIG. 3.

FIG. 5 is a lower perspective view of a reflector shown in FIG. 2.

FIG. 6 is an upper perspective view of a shade shown in FIG. 2.

FIG. 7 is a view that shows, in a perspective manner, a low-beam light distribution pattern formed on a virtual vertical screen disposed at a position 25 meters (“m”) ahead of the lamp by light radiated from the lamp unit shown in FIG. 2.

### DETAILED DESCRIPTION

Hereafter, embodiments of a vehicular lamp unit and a vehicular lamp according to the present invention will be described in detail with reference to accompanying drawings.

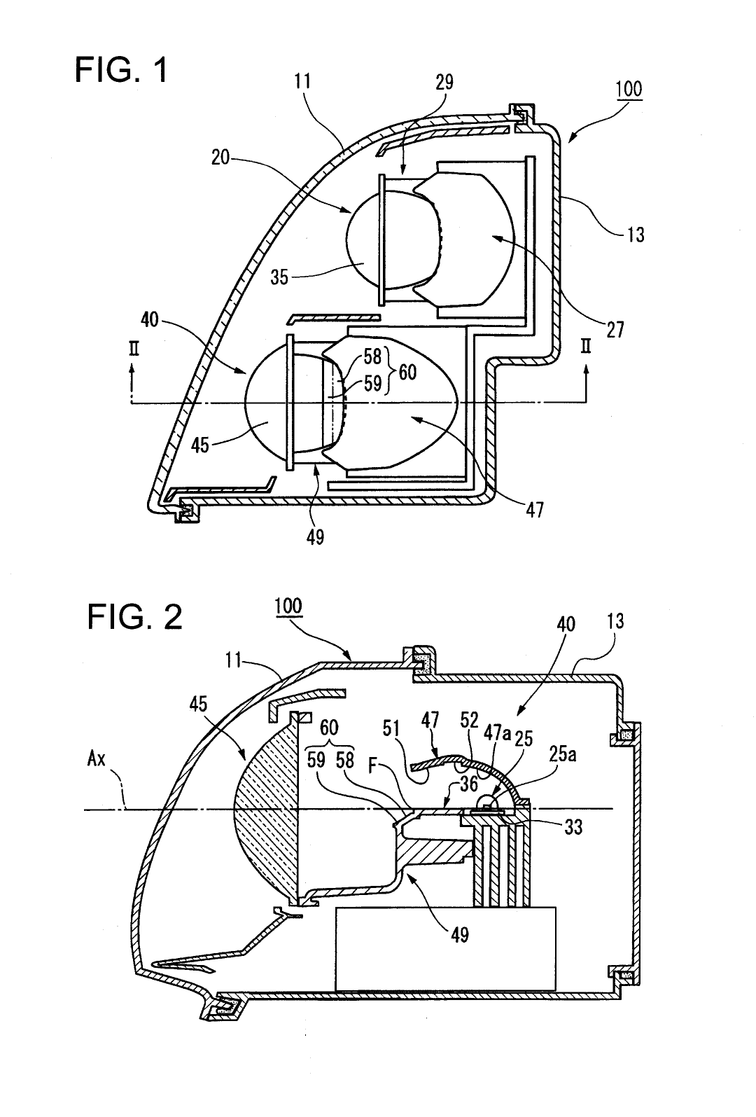

FIG. 1 is a horizontal cross sectional view of a vehicular lamp according to one or more embodiments of the present invention.

A vehicular lamp 100 is a low-beam headlamp, and is structured such that, in a lamp chamber formed of a plain translucent cover 11 and a lamp body 13, a plurality of lamp units (two are shown) are housed side-by-side. The plurality of lamp units are formed of a lamp unit (vehicular lamp unit) 40 having a high light collecting power and another lamp unit (another vehicular lamp unit) 20 having a light collecting power lower than that of the lamp unit 40.

These lamp units 20, 40 are supported in the lamp body 13 via a frame (not shown), and the frame is supported in the lamp body 13 via an aiming mechanism (not shown).

The aiming mechanism is a mechanism for finely adjusting attachment positions and attachment angles of these lamp units 20, 40. The aiming mechanism is designed such that when the aiming adjustment is completed, a lens central axis Ax of each of the lamp units 20, 40 extends in a downward direction by about 0.5 to 0.6 degrees relative to a vehicular longitudinal direction.

As will be described later, the lamp unit 20 forms a diffusion zone formation pattern WZ having horizontal and oblique cut-off lines on an upper end edge thereof. The lamp unit 40 forms a hot zone formation pattern HZ having horizontal and oblique cut-off lines on an upper end edge thereof

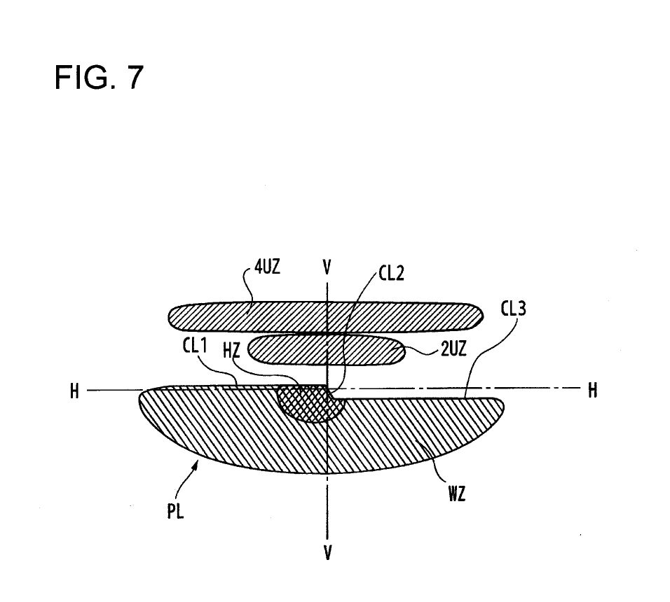

Specifically, a low-beam light distribution pattern PL formed by the vehicular lamp 100 is designed to be formed as a combined light distribution pattern of the diffusion zone formation pattern WZ and the hot zone formation pattern HZ formed by these two lamp units 20, 40 (refer to FIG. 7).

These lamp units 20, 40, which serve as low-beam light distribution pattern forming units, are structured as projector-type lamp units each formed of a light source and a projection lens provided on a front side of the light source, as will be described later.

Hereinafter, a structure of each of the lamp units 20, 40 will be described.

Firstly, a structure of the lamp unit 40 will be described.

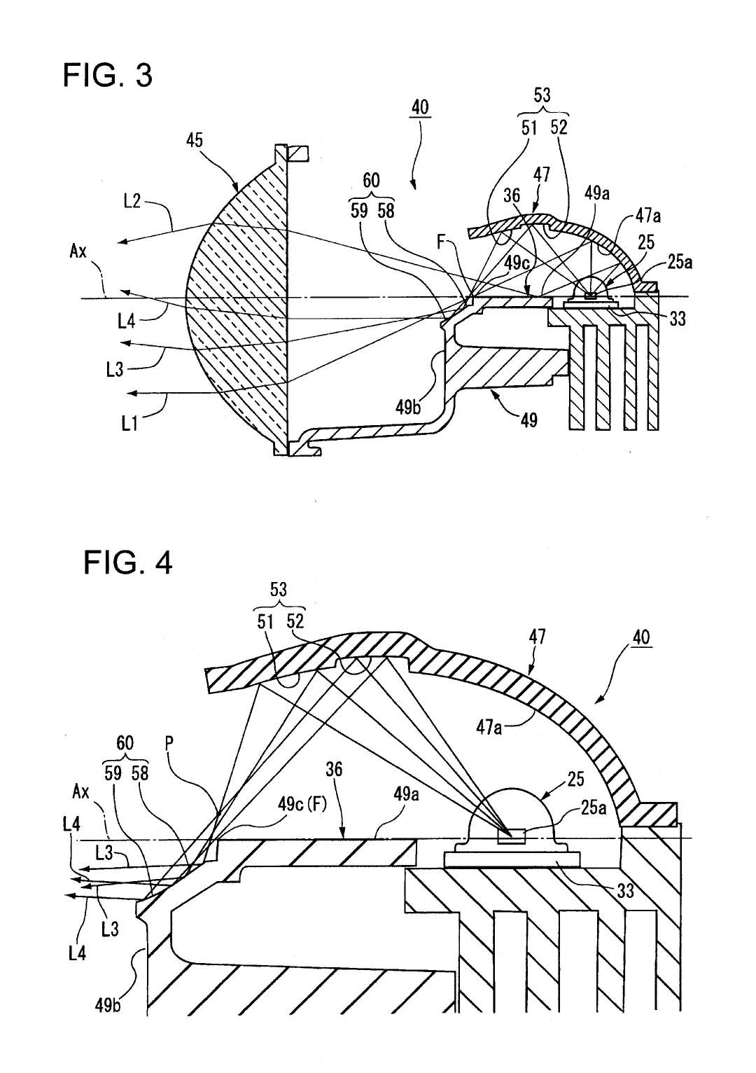

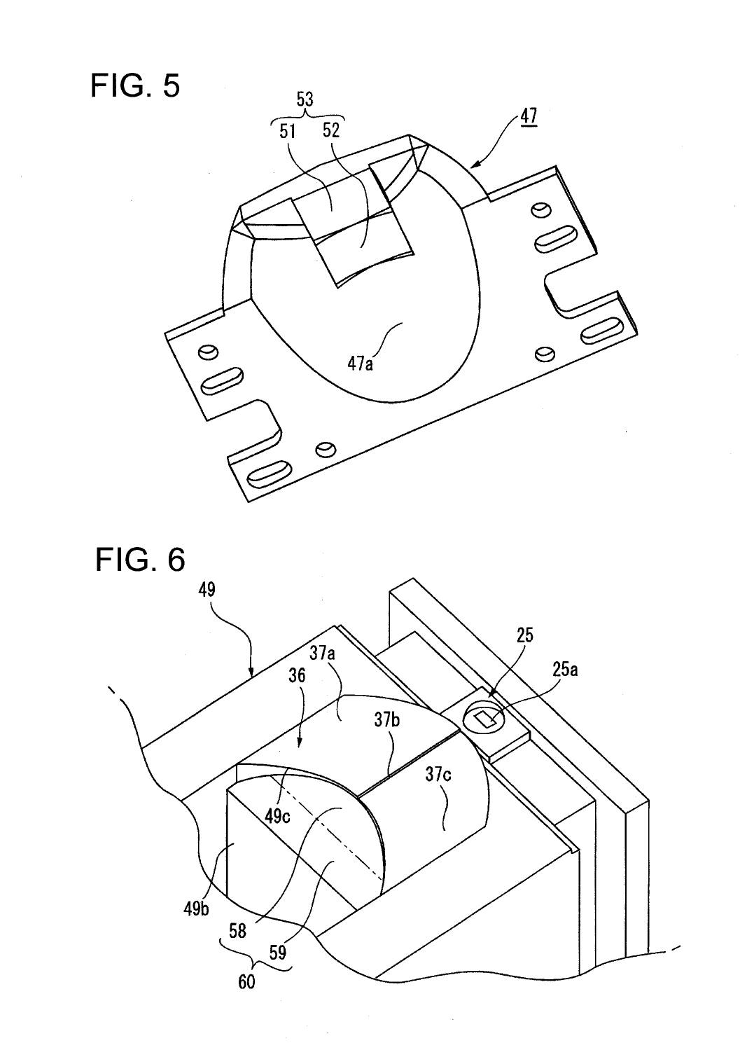

FIG. 2 is an arrow view along the line II-II in FIG. 1, FIG. 3 is a longitudinal sectional view that explains a basic structure of a lamp unit shown in FIG. 2, FIG. 4 is an expanded sectional view of a substantial portion of the lamp unit shown in FIG. 3, FIG. 5 is a lower perspective view of a reflector shown in FIG. 2, FIG. 6 is an upper perspective view of a shade shown in FIG. 2, and FIG. 7 is a view that shows, in a perspective manner, a low-beam light distribution pattern formed on a virtual vertical screen disposed at a position 25 meters (“m”) ahead of the lamp by light radiated from the lamp unit shown in FIG. 2.

As shown in FIG. 2, the lamp unit 40 includes a projection lens 45 disposed on an optical axis Ax extending in the vehicular longitudinal direction; an LED (light-emitting diode) 25 as a light source disposed rearward of a rear side focal point F of the projection lens 45; a reflector 47 that reflects direct light from the LED 25 to the front towards the optical axis Ax; and a shade 49 that is disposed between the projection lens 45 and the LED 25, and forms a cut-off line of a light distribution pattern by blocking a part of reflected light from the reflector 47 and a part of the direct light from the LED 25.

The LED 25 is a white light-emitting diode having a single light-emitting chip 25a whose size is about 1 millimeter (“mm”) square, for instance. The LED 25 is disposed rearward of the rear side focal point F of the projection lens 45, and directed upward in the vertical direction on the optical axis Ax in the state where the LED 25 is supported by a substrate 33.

As shown in FIG. 3 and FIG. 4, the reflector 47 is a generally dome-shaped member provided on an upper side of the LED 25, and has a reflective surface 47a that collects and reflects light L1 from the LED 25 to the front towards the optical axis Ax.

This reflective surface 47a is formed in a shape of an ellipsoidal reflective surface in which the optical axis Ax is set as a central axis. Specifically, this reflective surface 47a has a vertical cross-section including the optical axis Ax that is set to be a generally ellipsoidal shape, and an eccentricity thereof is set to gradually increase from the vertical cross-section to a horizontal cross-section.

However, rear side vertexes of ellipses forming the respective cross-sections are set at the same position, and the LED 25 is disposed on a first focal point of the ellipse forming the vertical cross-section of this reflective surface 47a. Accordingly, it is designed such that the reflective surface 47a collects and reflects the light L1 from the LED 25 to the front towards the optical axis Ax, and, at that time, the light is generally converged on a second focal point of the ellipse on the vertical cross-section including the optical axis Ax.

Further, a first reflective surface 53 that reflects a part of the direct light from the

LED 25 downward to the front of the shade 49 is formed on a tip portion of the reflector 47, as shown in FIG. 5.

The first reflective surface 53 is formed further on a tip portion of an effective reflective surface of the reflective surface 47a of the reflector 47. The first reflective surface 53 has a front-side first reflective surface 51 and a rear-side first reflective surface 52, which are divided in a longitudinal direction.

The front-side first reflective surface 51 is formed in a shape of an ellipsoidal reflective surface having a vertical cross-section that is generally ellipsoidal in shape and whose first focal point and second focal point P are respectively set to the LED 25 and a position above the rear side focal point F of the projection lens 45. The front-side first reflective surface 51 reflects the light from the LED 25 towards an upper-side second reflective surface 58 of a second reflective surface 60 formed on the front of the shade 49 for left-side light distribution that forms a cut-off line of a light distribution pattern for left-side light distribution and below the rear side focal point F of the projection lens 45.

The rear-side first reflective surface 52 is formed in a shape of a parabolic reflective surface having a vertical cross-section that is generally parabolic in shape and whose focal point is set to the LED 25. The rear-side first reflective surface 52 reflects the light from the LED 25 towards a lower-side second reflective surface 59 of the second reflective surface 60.

The second reflective surface 60 is formed on the front of the shade 49 and below the rear side focal point F of the projection lens 45. The second reflective surface 60 reflects the reflected light from the first reflective surface 53 towards the projection lens 45 so that the upward directed radiated light is emitted from the projection lens 45.

Further, the second reflective surface 60 has an upper-side second reflective surface 58 and a lower-side second reflective surface 59, which are divided in a vertical direction by an imaginary line shown in FIG. 1 and FIG. 6.

Accordingly, the reflected light from the front-side first reflective surface 51 is incident on the upper-side second reflective surface 58, and the reflected light from the rear-side first reflective surface 52 is incident on the lower-side second reflective surface 59. Subsequently, the radiated light provided by the lower-side second reflective surface 59 formed in a shape of a generally curved surface having a curved vertical cross-section radiates above the radiated light provided by the upper-side second reflective surface 58 formed in a shape of a generally flat surface having a linear vertical cross-section.

Note that the lower-side second reflective surface 59 is smoothly formed continuously to a lower portion of the upper-side second reflective surface 58.

Further, the lamp unit 40 is structured such that reflected light L3 reflected by the front-side first reflective surface 51 and the upper-side second reflective surface 58 radiates “4L, V, 4R” on 2U in a low-beam left-side light distribution pattern with a predetermined amount of light, and reflected light L4 reflected by the rear-side first reflective surface 52 and the lower-side second reflective surface 59 radiates “8L, V, 8R” on 4U in the pattern with a predetermined amount of light, which is a requirement imposed by European regulations (ECE R112) (refer to FIG. 7).

The projection lens 45 is formed of a planoconvex lens that has a convex front side surface and a flat rear side surface. This projection lens 45 is disposed on the optical axis Ax so that the rear side focal point F thereof is positioned on a second focal point of the reflective surface 47a of the reflector 47, as shown in FIG. 3. Accordingly, an image on a focal plane including the rear side focal point F is set to be projected forward as an inverted image.

In one or more embodiments of the present invention, the shade 49 has a shape of a block that also serves as a supporting frame of the projection lens 45, and the shade 49 is disposed between the projection lens 45 and the LED 25, as shown in FIG. 3 and FIG. 6. Further, the shade 49 has a front end edge 49c that positions in the vicinity of the rear side focal point F of the projection lens 45 and blocks a part of the reflected light from the reflector 47 to form a cut-off line of the left-side light distribution pattern, and the shade 49 has an upper surface 49a that extends rearward from the front end edge 49c and reflects a part of the reflected light from the reflector 47 on the upper side. A light control surface 36 to which reflective surface treatment is applied is formed on the upper surface 49a.

Specifically, the shade 49 is designed such that, by reflecting a part of the reflected light from the reflector 47 upward using the light control surface 36, most of the light to be emitted upward from the projection lens 45 is converted into the light L2 emitted downward from the projection lens 45, thereby enhancing a luminous flux utilization factor of the light emitted from the LED 25.

Specifically, the light control surface 36 is formed of a horizontal cut-off formation surface 37a extending horizontally in the right direction of a vehicle generally from the optical axis Ax (in the left direction in FIG. 6), an oblique cut-off formation surface 37b extending obliquely downward by 15° in the left direction generally from the optical axis Ax (in the right direction in FIG. 6), and a horizontal cut-off formation surface 37c extending horizontally in the left direction from the oblique cut-off formation surface 37b (in the right direction in FIG. 6). The front end edge (namely, an edge line between the light control surface 36 and a front end surface 49b of the shade 49) 49c is formed so as to pass through the rear side focal point F of the projection lens 45.

Further, of the light emitted from the LED 25, a part of the light reflected by the reflective surface 47a of the reflector 47 is incident on the light control surface 36 of the shade 49, and the remainder of the light is incident directly on the projection lens 45. At that time, the light incident on the light control surface 36 is reflected upward by the light control surface 36 and incident on the projection lens 45, whereby the light is emitted as the downward directed light L2 from the projection lens 45.

Note that the front end edge 49c of the shade 49 is formed in a curved shape in which lateral ends of the front end edge 49c protrude forward in a plan view so as to correspond to a field curvature of the projection lens 45. The curved front end edge 49c coincides with a focal group of the projection lens 45. Specifically, the front end edge 49c of the shade 49 is formed along the focal group of the projection lens 45, and a shape of the front end edge 49c directly corresponds to a shape of the cut-off line.

Further, the aforementioned second reflective surface 60 is integrally formed in the vicinity of the front end edge 49c of the shade 49.

Specifically, in the lamp unit 40 of one or more embodiments of the present invention, a part of the direct light from the LED 25 is reflected by the rear-side first reflective surface 52 having a shape of a parabolic reflective surface and the front-side first reflective surface 51 having a shape of an ellipsoidal reflective surface formed on the tip portion of the reflector 47. Then, the light is reflected towards the projection lens 45 by the upper-side second reflective surface 58 having a shape of a generally flat surface and the lower-side second reflective surface 59 having a shape of a generally curved surface formed on the front of the shade 49 and below the rear side focal point F of the projection lens 45, as shown in FIG. 3 and FIG. 4.

Subsequently, the light incident on the projection lens 45 from the upper-side second reflective surface 58 and the lower-side second reflective surface 59 are emitted as upward directed radiated lights L3, L4, which radiate above the low-beam light distribution pattern PL.

Next, the lamp unit 20 will be described.

As shown in FIG. 1, the lamp unit 20 includes a light-emitting diode (not shown) as a light source, a reflector 27, and a projection lens 35. The light-emitting diode has the same structure as that of the LED 25 of the lamp unit 40, and is disposed on an optical axis Ax and directed upward in the vertical direction.

The reflector 27 is a generally dome-shaped member provided on an upper side of the light-emitting diode. Further, the reflector 27 has a reflective surface having a shape of an ellipsoidal reflective surface that diffuses and reflects light from the light-emitting diode to the front, with low light collecting power compared to that of the reflective surface 47a of the reflector 47.

The projection lens 35 is formed of a planoconvex lens that has a convex front side surface and a flat rear side surface. The projection lens 35 is disposed on the optical axis Ax so that a rear side focal point of the projection lens 35 is positioned on a second focal point of the reflective surface of the reflector 27, and, accordingly, an image on a focal plane including the rear side focal point is set to be projected forward as an inverted image. Note that, because the radiated light from the lamp unit 20 is only required to reach a relatively shorter distance, the projection lens 35 uses a lens whose diameter is smaller than that of the projection lens 45 of the lamp unit 40.

Further, as shown in FIG. 7, the diffusion zone formation pattern WZ formed by the lamp unit 20 is a low-beam light distribution pattern for left-hand traffic having a cut-off line CL1 of a vehicle's own lane side and a cut-off line CL3 of an opposite lane side, which extend in a horizontal direction, and an oblique cut-off line CL2, on an upper end edge of the diffusion zone formation pattern WZ.

Further, the hot zone formation pattern HZ formed by the lamp unit 40 is formed to overlap with the diffusion zone formation pattern WZ, and is a hot zone formation pattern in which a light collecting power is higher than that in the diffusion zone formation pattern WZ.

Further, a light distribution pattern 2UZ is a light distribution pattern in which the reflected light L3 reflected by the front-side first reflective surface 51 and the upper-side second reflective surface 58 radiates “4L, V, 4R” on 2U in the low-beam left-side light distribution pattern with a predetermined amount of light. Further, a light distribution pattern 4UZ is a light distribution pattern in which the reflected light L4 reflected by the rear-side first reflective surface 52 and the lower-side second reflective surface 59 radiates “8L, V, 8R” on 4U in the low-beam left-side light distribution pattern with a predetermined amount of light.

Accordingly, the diffusion zone formation pattern WZ, the hot zone formation pattern HZ, and the light distribution patterns 2UZ and 4UZ overlap in the illustrated manner, thereby forming the low-beam light distribution pattern PL of the vehicular lamp 100 as a combined light distribution pattern.

Specifically, with the use of the vehicular lamp unit 40 of the vehicular lamp 100 according to one or more embodiments of the present invention, a part of the direct light from the LED 25 is reflected by the first reflective surface 53 formed on the tip portion of the reflector 47, and the light is then reflected towards the projection lens 45 by each of the vertically divided upper-side second reflective surface 58 and lower-side second reflective surface 59 formed on the front of the shade 49 and below the rear side focal point F of the projection lens 45. Subsequently, the light incident on the projection lens 45 from the upper-side second reflective surface 58 and the lower-side second reflective surface 59 is emitted as the upward directed radiated light L3, L4, respectively, which enables radiation of two, vertically-divided areas (2UZ and 4UZ) above the low-beam light distribution pattern PL.

Therefore, the vehicular lamp unit 40 can radiate the predetermined amount of reflected light with such a level that the light does not give a glare to a vehicle on the opposite lane, and also onto the two, vertically-divided areas above the low-beam light distribution pattern PL. Accordingly, it is possible to improve the forward visibility by forming an optimum light distribution pattern.

Further, when the reflected light from the front-side first reflective surface 51 formed in a shape of an ellipsoidal reflective surface is incident on the upper-side second reflective surface 58, and the reflected light from the rear-side first reflective surface 52 formed in a shape of a parabolic reflective surface is incident on the lower-side second reflective surface 59 as in the vehicular lamp unit 40 of one or more embodiments of the present invention, the light can be effectively incident on the upper-side second reflective surface 58 on which it is difficult for the reflected light from the first reflective surface 53 to be incident.

Further, the upper-side second reflective surface 58 of one or more embodiments of the present invention is formed in a shape of a generally flat surface having a linear vertical cross-section, and the lower-side second reflective surface 59 is formed in a shape of a generally curved surface having a curved vertical cross-section and is smoothly formed continuously to the lower portion of the upper-side second reflective surface 58.

Therefore, the lower-side second reflective surface 59 formed in a shape of a generally curved surface can effectively reflect the reflected light from the rear-side first reflective surface 52 having a sharp angle towards the projection lens 45 without interfering with the reflected light from the reflector 47. Further, because the lower-side second reflective surface 59 is smoothly continued to the lower portion of the upper-side second reflective surface 58, an unevenness is unlikely to occur in the upward directed radiated light emitted from the projection lens 45.

Further, the lamp unit 40 of one or more embodiments of the present invention is used as a light collecting-type lamp unit having the highest light collecting power in the vehicular lamp 100 that combines a light distribution from another vehicular lamp unit 20 having a light collecting power lower than that of the lamp unit 40 to form the entire low-beam light distribution pattern PL.

Accordingly, in cases that the vehicular lamp 100 combines the light distributions from the plurality of lamp units 20, 40 to form the entire low-beam light distribution pattern PL, by forming the first reflective surface 53 on the tip portion of the reflector 47 in the light collecting-type lamp unit 40 having a light collecting power higher than that of another lamp unit 20, it is possible to minimize an influence on an effective reflective surface of the reflector 47.

Specifically, for instance, the diffusing-type reflector 27 having a low light collecting power is formed with an effective reflective surface larger than that of the light collecting-type reflector 47, so that the front-side first reflective surface 51 and the rear-side first reflective surface 52, which are extended in the longitudinal direction, are formed on the tip portion of the reflector 27. Thus, the first reflective surface 53 blocks a part of the effective reflective surface, which influences a main light distribution pattern.

On the contrary, even if the front-side first reflective surface 51 and the rear-side first reflective surface 52, which are extended in the longitudinal direction, are formed on the tip portion of the light collecting-type reflector 47 having a high light collecting power, the first reflective surface 53 hardly blocks a part of the effective reflective surface to influence the main light distribution pattern.

The vehicular lamp unit and the vehicular lamp of the present invention may be modified in structure from the aforementioned embodiments, and various embodiments may be adopted within the spirit of the present invention.

For instance, although the vehicular lamp 100 of the aforementioned embodiments is structured such that the plurality of lamp units are housed side-by-side in the lamp chamber, one or more embodiments of the present invention may employ a single lamp unit. Further, the light source is described as a semiconductor light-emitting element such as a light-emitting diode, however, a discharge bulb such as a metal halide bulb and a halogen bulb may also be used.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

20 LAMP UNIT (ANOTHER VEHICULAR LAMP UNIT)

25 LED (LIGHT SOURCE)

40 LAMP UNIT (VEHICULAR LAMP UNIT)

47 REFLECTOR

49 SHADE

49a UPPER SURFACE

49c FRONT END EDGE

51 FRONT-SIDE FIRST REFLECTIVE SURFACE

52 REAR-SIDE FIRST REFLECTIVE SURFACE

53 FIRST REFLECTIVE SURFACE

45 PROJECTION LENS

36 LIGHT CONTROL SURFACE

58 UPPER-SIDE SECOND REFLECTIVE SURFACE

59 LOWER-SIDE SECOND REFLECTIVE SURFACE

60 SECOND REFLECTIVE SURFACE

100 VEHICULAR LAMP

Ax OPTICAL AXIS

CL CUT-OFF LINE

CL1 CUT-OFF LINE OF VEHICLE′S OWN LANE SIDE

CL2 OBLIQUE CUT-OFF LINE

CL3 CUT-OFF LINE OF OPPOSITE LANE SIDE

F REAR SIDE FOCAL POINT

What is claimed is:

1. A vehicular lamp unit comprising:
a projection lens disposed on an optical axis extending in a vehicular longitudinal direction,
a light source disposed rearward of a rear side focal point of the projection lens,
a reflector reflecting direct light from the light source forward towards the optical axis,
a shade disposed between the projection lens and the light source,
wherein the shade blocks a part of reflected light from the reflector and a part of the direct light from the light source to form a cut-off line of a light distribution pattern;
a first reflective surface formed on a tip portion of the reflector such that the first reflective surface reflects a part of the direct light from the light source downward to the front of the shade; and
a second reflective surface formed on the front of the shade and below the rear side focal point of the projection lens such that the second reflective surface reflects reflected light from the first reflective surface towards the projection lens so that upward directed radiated light is emitted from the projection lens,
wherein the second reflective surface comprises a vertically divided upper-side second reflective surface and lower-side second reflective surface, and
wherein radiated light provided by the lower-side second reflective surface radiates above radiated light provided by the upper-side second reflective surface.

2. The vehicular lamp unit according to claim 1,
wherein the first reflective surface comprises a front-side first reflective surface and a rear-side first reflective surface which are divided in a longitudinal direction;
wherein the front-side first reflective surface is formed in a shape of an ellipsoidal reflective surface having a vertical cross-section that is generally ellipsoidal in shape and whose first focal point and second focal point are respectively set to the light source and a position above the rear side focal point of the projection lens;
wherein the rear-side first reflective surface is formed in a shape of a parabolic reflective surface having a vertical cross-section that is generally parabolic in shape and whose focal point is set to the light source; and
wherein reflected light from the front-side first reflective surface is incident on the upper-side second reflective surface, and reflected light from the rear-side first reflective surface is incident on the lower-side second reflective surface.

3. The vehicular lamp unit according to claim 1,
wherein the upper-side second reflective surface is formed in a shape of a generally flat surface having a linear vertical cross-section; and
wherein the lower-side second reflective surface is formed in a shape of a generally curved surface having a curved vertical cross-section and is smoothly formed continuously to a lower portion of the upper-side second reflective surface.

4. A vehicular lamp wherein an entire light distribution pattern is formed by combining a light distribution from the vehicular lamp unit according to claim 1, and a light distribution from another vehicular lamp unit having a light collecting power lower than a light collecting power of the vehicular lamp unit.

5. The vehicular lamp unit according to claim 2,
wherein the upper-side second reflective surface is formed in a shape of a generally flat surface having a linear vertical cross-section; and
wherein the lower-side second reflective surface is formed in a shape of a generally curved surface having a curved vertical cross-section and is smoothly formed continuously to a lower portion of the upper-side second reflective surface.

6. A vehicular lamp wherein an entire light distribution pattern is formed by combining a light distribution from the vehicular lamp unit according to claim 2, and a light distribution from another vehicular lamp unit having a light collecting power lower than a light collecting power of the vehicular lamp unit.

7. A vehicular lamp wherein an entire light distribution pattern is formed by combining a light distribution from the vehicular lamp unit according to claim 3, and a light distribution from another vehicular lamp unit having a light collecting power lower than a light collecting power of the vehicular lamp unit.

8. A vehicular lamp wherein an entire light distribution pattern is formed by combining a light distribution from the vehicular lamp unit according to claim 5, and a light distribution from another vehicular lamp unit having a light collecting power lower than a light collecting power of the vehicular lamp unit.

9. A method of manufacturing a vehicular lamp unit comprising:
disposing a projection lens on an optical axis extending in a vehicular longitudinal direction,
disposing a light source rearward of a rear side focal point of the projection lens,
disposing a reflector so as to reflect direct light from the light source forward towards the optical axis,
disposing a shade between the projection lens and the light source such that the shade blocks a part of reflected light from the reflector and a part of the direct light from the light source to form a cut-off line of a light distribution pattern;
forming a first reflective surface on a tip portion of the reflector such that the first reflective surface reflects a part of the direct light from the light source downward to the front of the shade; and
forming a second reflective surface on the front of the shade and below the rear side focal point of the projection lens such that the second reflective surface reflects reflected light from the first reflective surface towards the projection lens so that upward directed radiated light is emitted from the projection lens,
wherein the second reflective surface comprises a vertically divided upper-side second reflective surface and lower-side second reflective surface, and
wherein radiated light provided by the lower-side second reflective surface radiates above radiated light provided by the upper-side second reflective surface.

10. The method according to claim 9,
wherein the first reflective surface comprises a front-side first reflective surface and a rear-side first reflective surface which are divided in a longitudinal direction;
wherein the front-side first reflective surface is formed in a shape of an ellipsoidal reflective surface having a vertical cross-section that is generally ellipsoidal in shape and whose first focal point and second focal point are respectively set to the light source and a position above the rear side focal point of the projection lens;
wherein the rear-side first reflective surface is formed in a shape of a parabolic reflective surface having a vertical cross-section that is generally parabolic in shape and whose focal point is set to the light source; and
wherein reflected light from the front-side first reflective surface is incident on the upper-side second reflective surface, and reflected light from the rear-side first reflective surface is incident on the lower-side second reflective surface.

11. The method according to claim 9,
wherein the upper-side second reflective surface is formed in a shape of a generally flat surface having a linear vertical cross-section; and
wherein the lower-side second reflective surface is formed in a shape of a generally curved surface having a curved vertical cross-section and is smoothly formed continuously to a lower portion of the upper-side second reflective surface.

12. A method of forming an entire light distribution pattern comprising:
combining a light distribution of the vehicular lamp unit manufactured according to the method of claim 9, and a light distribution from another vehicular lamp unit having a light collecting power lower than a light collecting power of the vehicular lamp unit.

13. The method according to claim 10,
wherein the upper-side second reflective surface is formed in a shape of a generally flat surface having a linear vertical cross-section; and
wherein the lower-side second reflective surface is formed in a shape of a generally curved surface having a curved vertical cross-section and is smoothly formed continuously to a lower portion of the upper-side second reflective surface.

14. A method of forming an entire light distribution pattern comprising:
combining a light distribution from the vehicular lamp unit manufactured according to the method of claim 10, and a light distribution from another vehicular lamp unit having a light collecting power lower than a light collecting power of the vehicular lamp unit.

15. A method of forming an entire light distribution pattern comprising:
combining a light distribution from the vehicular lamp unit manufactured according to the method of claim 11, and a light distribution from another vehicular lamp unit having a light collecting power lower than a light collecting power of the vehicular lamp unit.

16. A method of forming an entire light distribution pattern comprising:
combining a light distribution from the vehicular lamp unit manufactured according to the method of claim 13, and a light distribution from another vehicular lamp unit having a light collecting power lower than a light collecting power of the vehicular lamp unit.
